(19) United States
(12) Patent Application Publication
(10) Pub. No.: US 2013/0135321 A1
(43) Pub. Date: May 30, 2013

(54) Three-Dimensional Display Apparatus Electromechanical System

(71) Applicants: Anjan Ghosh Hajra, Salina, KS (US); Swapan Chakrabarti, Lawrence, KS (US); Raju S. Dandu, Salina, KS (US)

(72) Inventors: Anjan Ghosh Hajra, Salina, KS (US); Swapan Chakrabarti, Lawrence, KS (US); Raju S. Dandu, Salina, KS (US)

(73) Assignee: Immersion 3D Plus L.L.C., Salina, KS (US)

(21) Appl. No.: 13/485,728

(22) Filed: May 31, 2012

Related U.S. Application Data
(60) Provisional application No. 61/492,863, filed on Jun. 3, 2011.

(51) Int. Cl. G06T 15/00

(52) U.S. Cl. CPC G06T 15/00
USPC 345/501

(57) ABSTRACT

A three-dimensional display apparatus electromechanical system for displaying three-dimensional images without special viewing aids is disclosed. The electromechanical apparatus includes three flat surface screens, two rotating wheels or single screen not limited to other variations that will enable similar operation of the apparatus. The imaging system includes a CRT or similar device and control system to generate two-dimensional images to project the images at different depth locations through a focus system on to the moving projection screens.

### CROSS-REFERENCE TO RELATED APPLICATIONS

This application claims priority from U.S. patent application Ser. No. 61/492,863 filed on Jun. 3, 2011 in the United States Patent and Trademark Office, the disclosure of which is incorporated herein by reference.

### BACKGROUND OF THE INVENTION

The present invention is in the field of three-dimensional display apparatus and system. More particularly, the present invention is a display apparatus of true three-dimensional images. The physical world is three-dimensional and several three-dimensional display devices and systems have been developed to display and visualize images in three-dimensional form. Most of the systems and devices developed are expensive, need special viewing aids, and lack visualization of true depth of images. The lack of true three-dimensional image display limits visualization, analysis and use of data. A user friendly and less expensive true three-dimensional display apparatus will add a new dimension and hold the promise of enhancing and advancing the physical world of medical imaging, entertainment, and engineering fields.

### BRIEF SUMMARY OF THE INVENTION

The present invention is a three-dimensional display apparatus electromechanical system with either three flat surfaces or plates acting as projection screens attached to one or two rotating wheels, or a single flat surface or plate acting as projection screen attached to one or two rotating circular plates or bars to display true depth three-dimensional images that does not require special viewing aids, reliable, less expensive, and user friendly.

### BRIEF DESCRIPTION OF THE SEVERAL VIEWS OF THE DRAWINGS

FIG. 1 is a schematic diagram of a three screen display device and system.

FIG. 2 is a schematic diagram shown in isometric view of three screens and screen assembly of the display apparatus.

FIG. 3 is a schematic front view of the three screens and screen assembly of the display apparatus.

FIG. 4a is a schematic side view of three screens and screen assembly of the display apparatus.

FIG. 4b is a schematic view of pulleys of the display apparatus.

FIG. 5 is a schematic isometric view of pulleys, screens, rotating plates of display apparatus assembly.

FIG. 6 is a schematic diagram shown in isometric view of three screen three-dimensional display apparatus.

FIG. 7 is a schematic diagram shown in isometric view of a single screen three-dimensional display apparatus.

FIG. 8 is a schematic diagram of top view of a single screen three-dimensional display apparatus.

FIG. 9 is a schematic diagram of side view of a single screen three-dimensional display apparatus.

### DETAILED DESCRIPTION OF THE INVENTION

The present invention will now be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements.

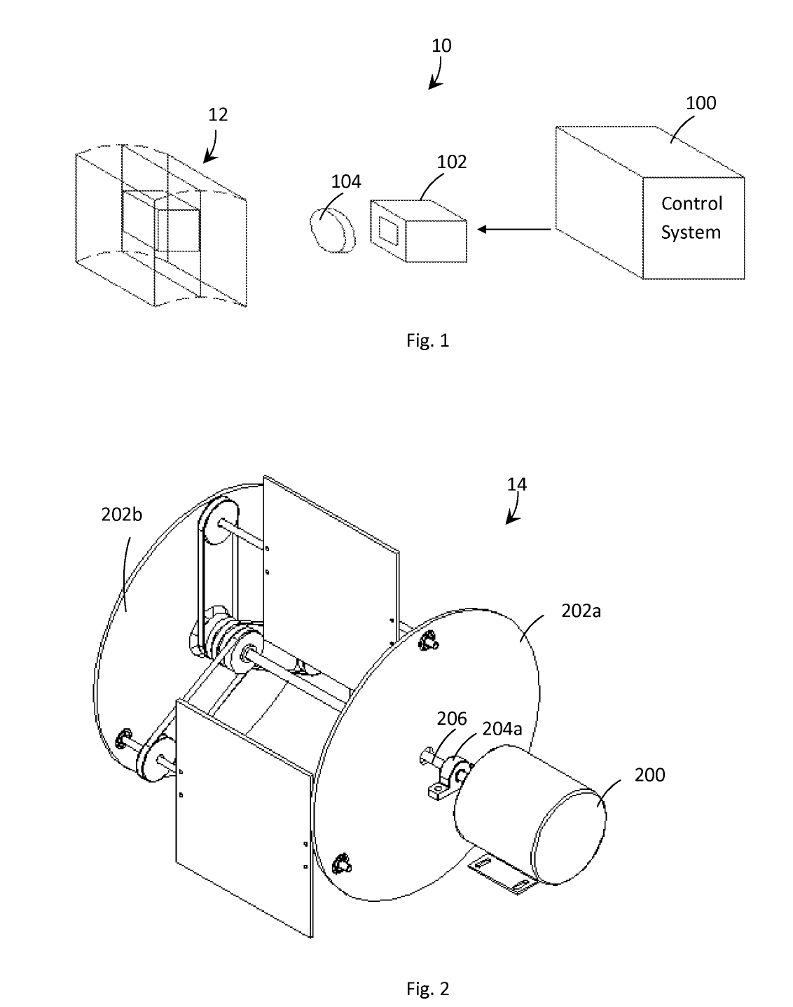

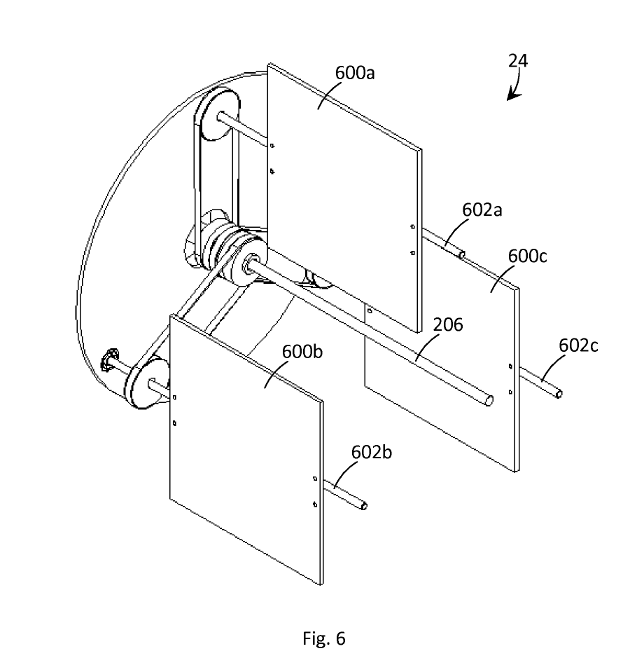

FIG. 1 illustrates schematically a three-dimensional display apparatus system 10 in which an embodiment of the present invention is implemented. This display apparatus generates and displays true three-dimensional images that can be viewed without the assistance of special viewing aids. The display apparatus assembly includes a CRT 102 or similar device for generating the two-dimensional images, a focusing system 104 for focusing the images from the CRT or similar device to the three screens of 24 shown in FIG. 6 as 600a, 600b, 600c, and a control system 100 for controlling the operation of the CRT and synchronizing the generation of the two-dimensional images with different depth positions displayed on the three moving screens.

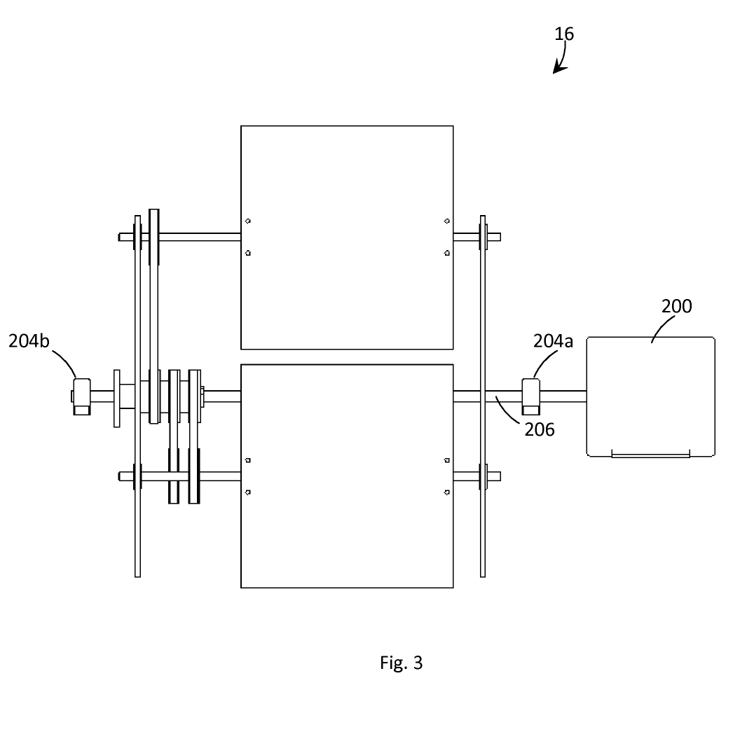

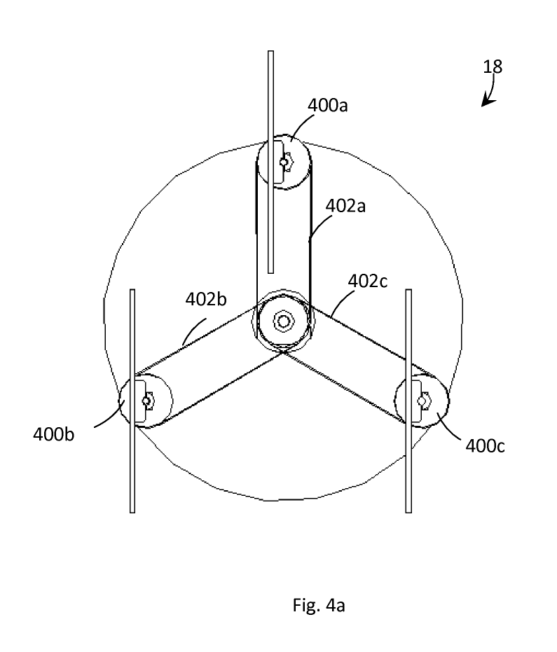

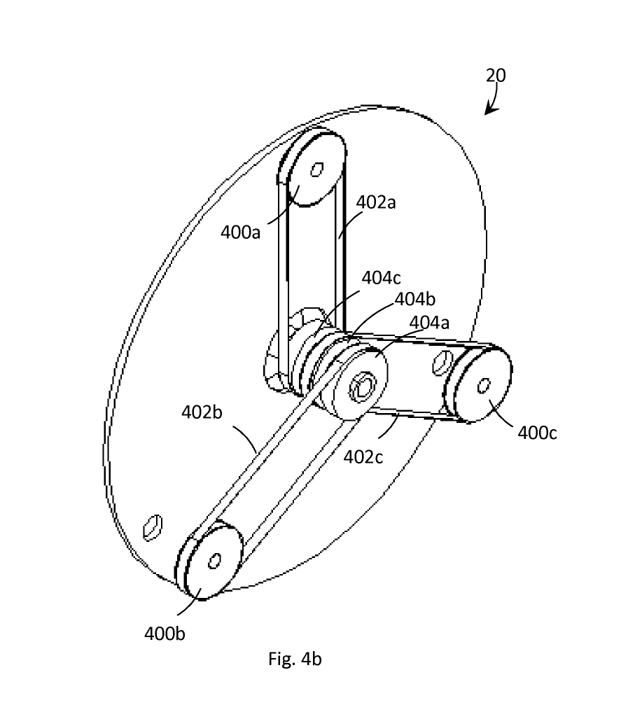

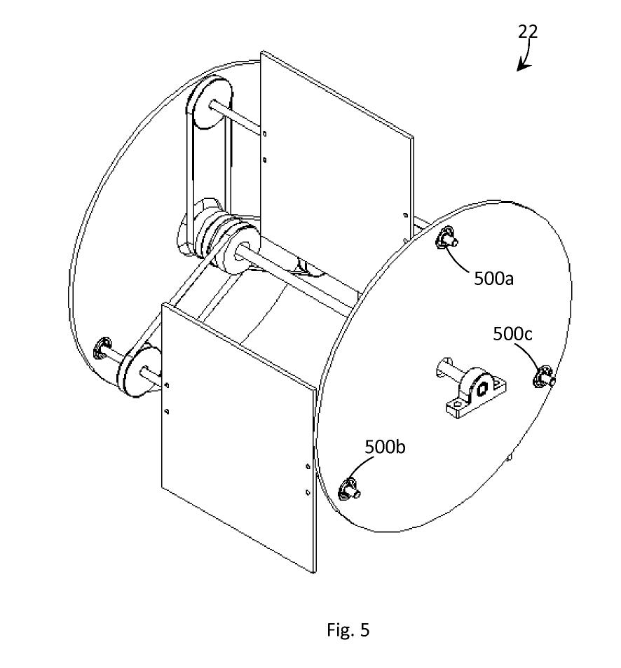

FIGS. 2, 3, 4a, 4b, 5 and 6 the display apparatus includes three flat projection screens 600a, 600b, 600c, two rotating circular plates 202a, 202b where the flat projection screens are held in vertical position as they rotate in circular motion for generating and displaying images on the screens while the screens are moved in circular direction representing different depth locations of the image. The display apparatus generates and displays three-dimensional images over a fixed volumetric space when three flat projection screens are rotating in circular motion. So each flat projection screen becomes a moving projection screen. When all three screens rotate with circular plates, at a rate of 20 revolutions per second creating a display volume (3×20) 60 times per second. By rotating circular plates at a rate of 10 revolutions per second the display volume is created 30 times per second. This display volume rate is good enough to provide flicker free views of the three-dimensional display of the image. As the circular plates rotate, each screen movement represents different depth positions of the image projected on to the moving projection screens.

The flat projection screen can be of any commercially available projection screen and may be sized to display desired size of the image based on the type of application.

As illustrated in FIGS. 2, 3, 4a, 4b, 5 and 6, the flat projection screens 600a, 600b, 600c are attached to screen rods 70, 72, 74. The screen rods 602a, 602b, 602c are attached to circular rotating plates 202a, 202b and held by bushings 500a, 500b, and 500c. Three reference timing pulleys 400a, 400b, 400c are attached to three screen rods and timing belts 402a, 402b, 402c are connected to stationary timing pulleys 404a, 404b, 404c that are mounted and fixed to a plate.

The main shaft 206 passes through the center of stationary pulleys 404a, 404b, and 404c and also through the center of the circular rotating plates and connected to the circular rotating plates. The main shaft ends are attached to bearings 204a, 204b. The main shaft is connected to the electric motor 200. As a result, when the main shaft is rotated by the aid of an electric motor, all three flat projections screens rotate with circular plates. However, due to the use of reference timing pulleys and timing belts for flat screens where the other end of the timing belt is connected to stationary pulleys, the flat projection screens do not change their orientation and move in synchronization when the circular plates rotate. Thus, the flat projection screens remain vertically oriented throughout the motion while the circular plates rotate.

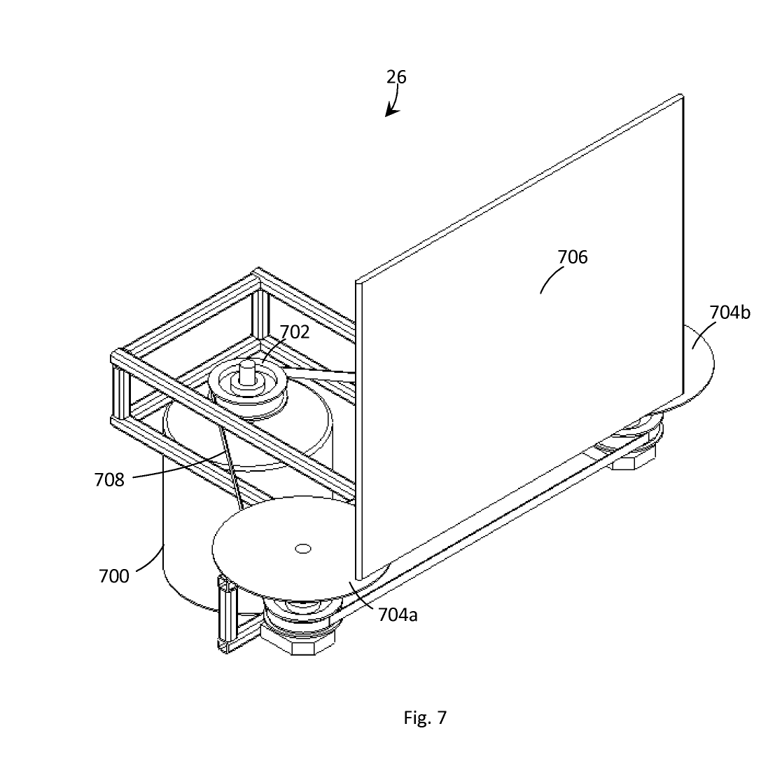

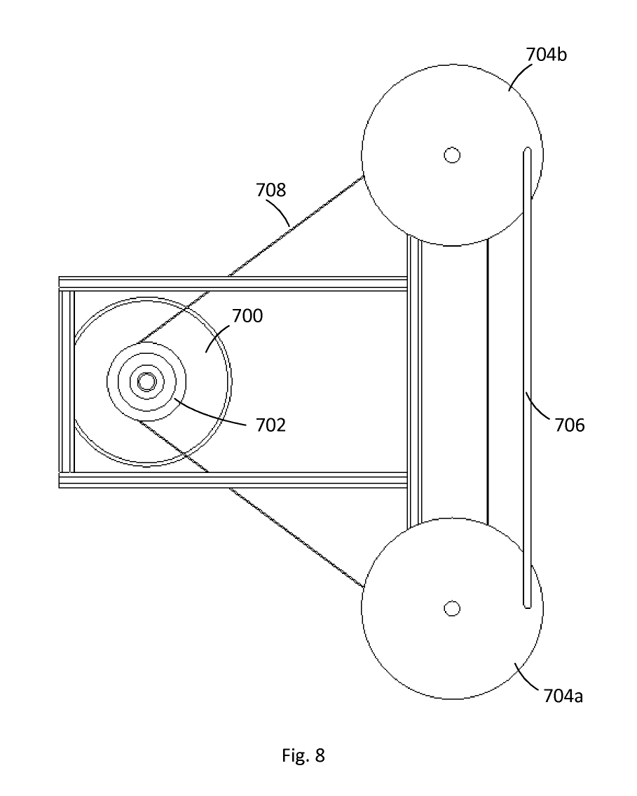

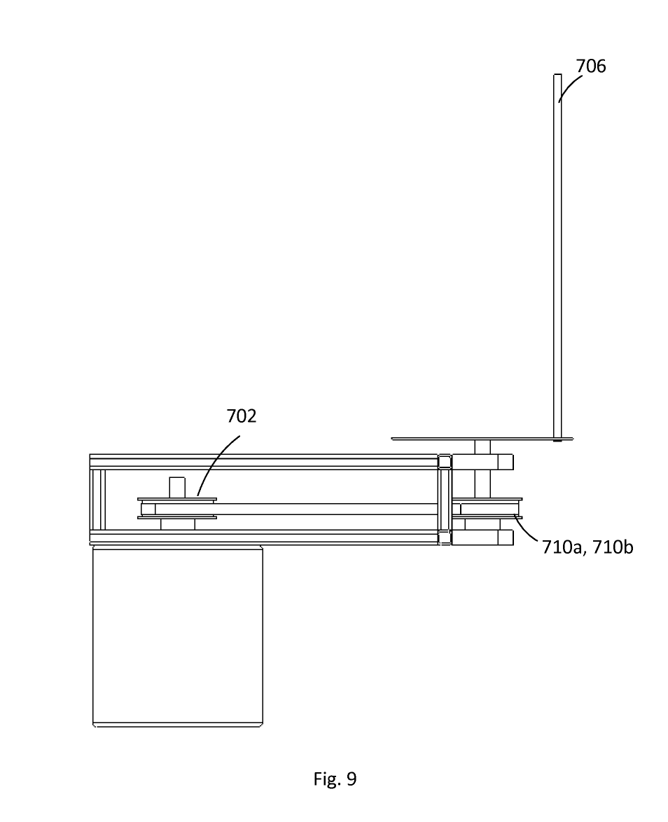

Another variation of display apparatus with single screen attached to one or two rotating disks is illustrated in FIGS. 7, 8, 9. The single screen is attached to one or two rotating disks or similar mechanism or device to provide the circular motion of the screen. While the disks are connected with pulleys 710a, 710b attached to shafts. Pulleys 710a, 710b, and pulley 702 mounted on electrical motor 700 shaft is connected by belt 708. The single screen will act as a moving projection screen to display the image in the volumetric space.

Control system 100 uses a graphics card with Genlock input and has the ability to synchronize its v-sync with an external pulse, and such a card often provides a minimum of 60 Hz refresh rate. When such a graphics card is used in combination with this electromechanical system that rotates at a rate of 10 revolutions per second, then two images appear over a larger display volume. Using an RF switch eliminates the formation of one of the two images over that extended volumetric space. This can be accomplished by using a flip-flop connected to the RF switch when the flip-flop works in the toggle mode. The input pulses to this flip-flop come from the sensor that produces a pulse whenever a small blade cuts the path of the sensor's emitter-receiver path. Thus, by placing 6 blades on the rotating circular plates at the intervals of sixty degrees where three blades correspond to actual locations of the flat plates, eliminates every alternate image generated by the graphics card. So effectively, the graphics card generates 30 images per second over the display volume and those images are projected 10 times per second over each rotating flat plate.

1. A three-dimensional display apparatus electromechanical system comprising:
a display apparatus having rotating circular plates;
a set of flat plates, displays a sequence of projected two-dimensional images on said flat plates, during rotation of said plates creating a fixed volumetric space in which said plates become moving projection screens;
a control system having a graphics card which generates said sequence of two-dimensional images having the ability to synchronize with position of said flat plates by projecting a plurality of individual said images of a three-dimensional image;
a plurality of individual images when projected on said flat plates creates a three-dimensional image in swept volumetric space;
a sensor that produces a signal and sends to a flip flop to synchronize projection of generated two-dimensional images; and
a flip flop which connected to RF switch to control images generated by the graphics card.

2. The system of claim 1 wherein said display apparatus includes:
a motor having a rotating shaft as well as other kinds of rotating mechanism;
a set of two circular plates attached to a shaft rotating about a common axis;
a set of timing pulleys; and
a set of stationary shafts.

3. The display apparatus having rotating circular plates in claim 1 wherein two circular plates are made of lightweight materials as well as other materials.

4. The display apparatus having a set of flat plates in claim 1 wherein three flat plates acting as moving projection screens and said flat plates are held in vertical position during rotation.

5. The flat plates in claim 4 wherein the plates are made of lightweight materials as well as smart flat plate material capable of switching between transparent and translucent mode.

6. The rotating circular plates in claim 3 wherein three flat plates are held by shafts which are attached to the circular plates.

7. A set of timing pulleys in claim 2 wherein two timing pulleys for each flat plate are attached to two rotating circular plates and a timing belt is connected to each pulley, and the other end of the said belt is connected to a stationary timing pulley.

8. The shaft rotating about a common axis in claim 2 wherein the shaft passes through the center of the stationary pulley and the rotating circular plates.

9. The graphics card in claim 1 comprises of a Genlock input;

10. The Genlock input in claim 9 wherein the said graphic card provides a refresh rate for flicker-free viewing and the said input is able to synchronize v-sync pulse of the graphics card with an external pulse signal.

11. The flip flop connected to RF switch in claim 1 when works in toggle mode will eliminate the formation of additional said three-dimensional images in the volumetric space.
